(19) United States
(12) Patent Application Publication
(10) Pub. No.: US 2026/0222777 A1
(43) Pub. Date: Jul. 30, 2026

(54) METHOD AND DEVICE FOR INVOKING SERVICE, DEVICE, AND STORAGE MEDIUM

(71) Applicant: Beijing Xiaomi Mobile Software Co., Ltd., Beijing (CN)

(72) Inventors: Dong CHEN, Beijing (CN); Zhibin HE, Beijing (CN)

(21) Appl. No.: 19/142,561

(22) PCT Filed: Dec. 26, 2022
(86) PCT No.: PCT/CN2022/142080

§ 371 Date: Jun. 23, 2025

(51) Int. Cl. H04W 4/50; H04W 8/20; H04W 72/12; H04W 76/10

(52) U.S. Cl. CPC H04W 4/50; H04W 8/20; H04W 72/12; H04W 76/10

(57) ABSTRACT

A method for invoking a service, performed by a session management function (SMF) network element, the method comprising: receiving a service invocation request, where the service invocation request indicates at least one of a terminal requesting to invoke a service or a service that the terminal requests to invoke; establishing a connection with a first network element, wherein the first network element is a network element providing the service that the terminal requests to invoke; determining a resource configured to execute the service by interacting with a base station; and transmitting resource indication information to the first network element, wherein the resource indication information indicates the resource configured to execute the service, and the resource indication information is configured for the first network element to establish a user plane connection with the terminal based on the resource indication information.

### CROSS-REFERENCE TO RELATED APPLICATION

The present application is a U.S. National Stage of International Application No. PCT/CN2022/142080, filed on Dec. 26, 2022, the contents of all of which are incorporated herein by reference in their entirety for all purposes.

### BACKGROUND OF THE INVENTION

A variety of new services (such as a computing power service and a sensing service) will be introduced into a future network system, so as to improve richness of network services. Generally, a terminal may provide a more personalized service for a user by invoking a service in a network device.

### SUMMARY OF THE INVENTION

The present disclosure relates to the technical field of communication, and in particular to a method and device for invoking a service, a device, and a storage medium.

In a first aspect, a method for invoking a service is provided in embodiments of the present disclosure. The method is performed by a session management function (SMF) network element and includes:
receiving a service invocation request, where the service invocation request indicates at least one of a terminal requesting to invoke a service or a service that the terminal requests to invoke;
establishing a connection with a first network element, where the first network element is a network element providing the service that the terminal requests to invoke;
determining, by interacting with a base station, a resource configured to execute the service; and
transmitting resource indication information to the first network element, where the resource indication information indicates the resource configured to execute the service, and the resource indication information is configured for the first network element to establish a user plane connection with the terminal based on the resource indication information.

In a second aspect, a method for invoking a service is provided in the embodiments of the present disclosure. The method is performed by a base station and includes:
receiving a resource scheduling request transmitted by an SMF network element, where the resource scheduling request is configured to request the base station to schedule, for a terminal, a resource configured to execute a service;
scheduling, for the terminal, the resource configured to execute the service; and
transmitting resource indication information to the SMF network element, where the resource indication information indicates the resource scheduled by the base station for the terminal and configured to execute the service.

In a third aspect, a method for invoking a service is provided in the embodiments of the present disclosure. The method is performed by a first network element, where the first network element is a network element providing a service that a terminal requests to invoke. The method includes:
establishing a connection with an SMF network element;
receiving resource indication information transmitted by the SMF network element, where the resource indication information indicates a resource configured to execute a service that the terminal requests to invoke;
establishing a user plane connection with the terminal based on the resource indication information; and
communicating with the terminal for invocation of the service.

In a fourth aspect, a method for invoking a service is provided in the embodiments of the present disclosure. The method is performed by an access and mobility management function (AMF) network element and includes:
receiving a service invocation request transmitted by a terminal, where the service invocation request indicates at least one of the terminal requesting to invoke a service or a service that the terminal requests to invoke; and
transmitting the service invocation request to an SMF network element.

In a fifth aspect, a method for invoking a service is provided in the embodiments of the present disclosure. The method is performed by a terminal and includes:
transmitting a service invocation request to an AMF network element, where the service invocation request indicates at least one of the terminal requesting to invoke a service or a service that the terminal requests to invoke;
receiving a resource scheduled by a base station and configured to execute the service;
establishing a user plane connection with a first network element based on the resource configured to execute the service, where the first network element is a network element providing the service that the terminal requests to invoke; and
invoking the service by communicating with the first network element.

In a sixth aspect, a communication device is provided in the embodiments of the present disclosure. The communication device is configured in an SMF network element and includes:
a transceiving module configured to receive a service invocation request, where the service invocation request indicates at least one of a terminal requesting to invoke a service or a service that the terminal requests to invoke; and
a processing module configured to establish a connection with a first network element, where the first network element is a network element providing the service that the terminal requests to invoke;
where the transceiving module is further configured to determine a resource configured to execute the service by interacting with a base station; and
the transceiving module is further configured to transmit resource indication information to the first network element, where the resource indication information indicates the resource configured to execute the service, and the resource indication information is configured for the first network element to establish a user plane connection with the terminal based on the resource indication information.

In a seventh aspect, a communication device is provided in the embodiments of the present disclosure. The communication device is configured in a base station and includes:
a transceiving module configured to receive a resource scheduling request transmitted by an SMF network element, where the resource scheduling request is configured to request the base station to schedule for a terminal a resource configured to execute a service; and
a processing module configured to schedule for the terminal the resource configured to execute the service;
where the transceiving module is further configured to transmit resource indication information to the SMF network element, where the resource indication information indicates the resource scheduled by the base station for the terminal and configured to execute the service.

In an eighth aspect, a communication device is provided in the embodiments of the present disclosure. The communication device is configured in a first network element and includes:
a processing module configured to establish a connection with an SMF network element; and
a transceiving module configured to receive resource indication information transmitted by the SMF network element, where the resource indication information indicates a resource configured to execute a service that a terminal requests to invoke;
where the processing module is further configured to establish a user plane connection with the terminal based on the resource indication information; and
the transceiving module is further configured to communicate with the terminal for invocation of the service.

In a ninth aspect, a communication device is provided in the embodiments of the present disclosure. The communication device is configured in an AMF network element and includes:
a transceiving module configured to receive a service invocation request transmitted by a terminal, where the service invocation request indicates at least one of the terminal requesting to invoke a service or a service that the terminal requests to invoke;
where the transceiving module is further configured to transmit the service invocation request to an SMF network element.

In a tenth aspect, a communication device is provided in the embodiments of the present disclosure. The communication device is configured in a terminal and includes:
a transceiving module configured to transmit a service invocation request to an AMF network element, where the service invocation request indicates at least one of the terminal requesting to invoke a service or a service that the terminal requests to invoke,
where the transceiving module is further configured to receive a resource scheduled by a base station and configured to execute the service; and
a processing module configured to establish a user plane connection with a first network element based on the resource configured to execute the service, where the first network element is a network element providing the service that the terminal requests to invoke;
where the transceiving module is further configured to invoke the service by communicating with the first network element.

In an eleventh aspect, a communication device is provided in the embodiments of the present disclosure. The communication device includes one or more processors, where the one or more processors, when collectively invoking a computer program in a memory, collectively performs the method in any one of the first aspect to the fifth aspect.

In a twelfth aspect, a communication device is provided in the embodiments of the present disclosure. The communication device includes one or more processors and a memory; where the memory stores a computer program, and the one or more processors, when collectively executing the computer program stored in the memory, causes the communication device to perform the method in any one of the first aspect to the fifth aspect.

In a thirteenth aspect, a communication device is provided in the embodiments of the present disclosure. The communication device includes one or more processors and an interface circuit; where the interface circuit is configured to receive code instructions, and transmit the code instructions to the one or more processors, and the one or more processors, when collectively running the code instructions, are collectively configured to cause the communication device to perform the method in any one of the first aspect to the fifth aspect.

In a fourteenth aspect, a communication system is provided in the embodiments of the present disclosure. The communication system includes the communication device in the fifth aspect to the communication device in the tenth aspect; alternatively, the communication system includes the communication device in the twelfth aspect; alternatively, the communication system includes the communication device in the thirteenth aspect; and alternatively, the communication system includes the communication device in the fourteenth aspect.

In a fifteen aspect, a non-transitory computer-readable storage medium is provided in the embodiments of the present disclosure. The non-transitory computer-readable storage medium is configured to store instructions used by the above-mentioned network device, where the instructions, when executed, cause the network device to perform the method in any one of the first aspect to the fourth aspect. The non-transitory computer-readable storage medium is further configured to store instructions used by the above-mentioned terminal, where the instructions, when executed, cause the terminal to perform the method in the fifth aspect.

In a sixteenth aspect, the present disclosure further provides a computer program product including a computer program. The computer program, when running on a computer, causes the computer to perform the method in any one of the first aspect to the fifth aspect.

In a seventeenth aspect, the present disclosure provides a chip system. The chip system includes at least one processor and an interface, and is configured to support a network device in implementing functions involved in the method in any one of the first aspect to the fourth aspect, such as determination or processing of at least one of data or information involved in the method. Alternatively, the chip system is further configured to support a terminal in implementing functions involved in the method in the fifth aspect, such as determination or processing of at least one of data or information involved in the method. In a design, the chip system further includes a memory, where the memory is configured to save a computer program and data necessary for a source auxiliary node. The chip system may be composed of a chip, or may include a chip and other discrete devices.

In an eighteenth aspect, the present disclosure provides a computer program. The computer program, when running on a computer, causes the computer to perform the method in any one of the first aspect to the fifth aspect.

In a nineteenth aspect, the present disclosure provides a communication method. The communication method is performed by a core network device and includes:
receiving a service invocation request transmitted by a terminal, where the service invocation request indicates at least one of the terminal requesting to invoke a service or a service that the terminal requests to invoke;
transmitting a resource scheduling request to a base station, where the resource scheduling request is configured to request the base station to schedule for the terminal a resource configured to execute the service;
receiving resource indication information transmitted by the base station, where the resource indication information indicates the resource scheduled by the base station for the terminal and configured to execute the service;
establishing a user plane connection with the terminal based on the resource indication information; and
communicating with the terminal for invocation of the service.

In a twentieth aspect, the present disclosure provides a communication system. The communication system is configured to perform the method in the nineteenth aspect.

In a twenty-first aspect, the present disclosure provides a communication method. The communication method includes:
receiving, by an AMF network element, a service invocation request transmitted by a terminal, and transmitting, by the AMF network element, the service invocation request to an SMF network element, where the service invocation request indicates at least one of the terminal requesting to invoke a service or a service that the terminal requests to invoke;
receiving, by the SMF network element, the service invocation request, and establishing, by the SMF network element, a connection with a first network element, where the first network element is a network element providing the service that the terminal requests to invoke;
establishing, by the first network element, the connection with the SMF network element;
transmitting, by the SMF network element, a resource scheduling request to a base station, where the resource scheduling request is configured to request the base station to schedule for the terminal a resource configured to execute the service;
receiving, by the SMF network element, resource indication information, and transmitting, by the SMF network element, the resource indication information to the first network element, where the resource indication information indicates the resource scheduled by the base station for the terminal and configured to execute the service;
receiving, by the first network element, the resource indication information transmitted by the SMF network element, and establishing, by the first network element, a user plane connection with the terminal based on the resource indication information; and
communicating with the terminal by the first network element for invocation of the service.

In a twenty-second aspect, the present disclosure provides a communication system. The communication system includes:
an SMF network element configured to perform the method in the first aspect;
a first network element configured to perform the method in the third aspect, where the first network element is a network element providing a service that a terminal requests to invoke; and
an AMF network element configured to perform the method in the fourth aspect.

### BRIEF DESCRIPTION OF DRAWINGS

The above and/or additional aspects and advantages of the present disclosure will become apparent and readily appreciated from the following description of embodiments in conjunction with the accompanying drawings.

FIG. 1 is a schematic diagram of an architecture of a communication system according to an embodiment of the present disclosure.

FIG. 2 is a schematic flowchart of a method for invoking a service according to another embodiment of the present disclosure.

FIG. 3 is a schematic flowchart of a method for invoking a service according to yet another embodiment of the present disclosure.

FIG. 4 is a schematic flowchart of a method for invoking a service according to yet another embodiment of the present disclosure.

FIG. 5 is a schematic flowchart of a method for invoking a service according to yet another embodiment of the present disclosure.

FIG. 6 is a schematic flowchart of a method for invoking a service according to yet another embodiment of the present disclosure.

FIG. 7 is a schematic flowchart of a method for invoking a service according to still another embodiment of the present disclosure.

FIG. 8 is a schematic flowchart of a method for invoking a service according to an embodiment of the present disclosure.

FIG. 9 is a schematic flowchart of an interaction method for invoking a service according to an embodiment of the present disclosure.

FIG. 10 is a schematic structural diagram of a communication device according to an embodiment of the present disclosure.

FIG. 11 is a schematic structural diagram of a communication device according to another embodiment of the present disclosure.

FIG. 12 is a schematic structural diagram of a communication device according to an embodiment of the present disclosure.

FIG. 13 is a schematic structural diagram of a communication device according to an embodiment of the present disclosure.

FIG. 14a is a schematic structural diagram of a communication device according to an embodiment of the present disclosure.

FIG. 14b is a schematic flowchart of a method for invoking a service according to an embodiment of the present disclosure.

FIG. 14c is a schematic flowchart of a method for invoking a service according to an embodiment of the present disclosure.

FIG. 14d is a schematic structural diagram of a communication system according to an embodiment of the present disclosure.

FIG. 15 is a block diagram of user equipment according to an embodiment of the present disclosure.

FIG. 16 is a block diagram of a network device according to an embodiment of the present disclosure.

### DETAILED DESCRIPTION OF THE INVENTION

Examples will be described in detail, and illustratively shown in the accompanying drawings. When the following description relates to the accompanying drawings, the same numbers in different accompanying drawings denote the same or similar elements, unless indicated otherwise. The implementations described in the examples do not denote all implementations consistent with embodiments of the present disclosure. On the contrary, the implementations are merely instances of devices and methods consistent with some aspects in the embodiments of the present disclosure as recited in the appended claims.

The terms used in the embodiments of the present disclosure are merely configured to describe particular embodiments, rather than limit the embodiments of the present disclosure. The singular forms “a,” “an” and “the” used in the embodiments and the appended claims of the present disclosure are also intended to include the plural forms, unless clearly stated in the context otherwise. It is also to be understood that the term “and/or” used in the disclosure indicates and encompasses one or any or all possible combinations of a plurality of associated items listed.

It is to be understood that the terms first, second, third, etc. may be employed in the embodiments of the present disclosure to describe various information, but do not limit these information. These terms are merely configured to distinguish between the same type of information. For example, first information or can be referred to as second information, and similarly, second information or can be referred to as first information, without departing from the scope of the embodiments of the present disclosure. Depending on the context, the word “if” as used in the disclosure can be interpreted as “at the time of . . . ,” “when . . . ” or “in response to determining”.

The embodiments of the present disclosure are described in detail below, and illustratively shown in the accompanying drawings. The same or similar reference numerals denote the same or similar elements throughout. The embodiments described below with reference to the accompanying drawings are illustrative and intended to explain the present disclosure, but cannot be interpreted as limiting the present disclosure.

Currently, it is a pressing issue to provide a method for invoking a service.

For ease of understanding, the terms involved in the present disclosure are described first.

### 1, Access and Mobility Management Function (AMF) Network Element

The AMF network element supports terminals having different mobility management demand. The AMF network element can execute tasks such as the following: a non-access stratum (NAS) signaling terminal; NAS signaling security; access stratum security control; core network inter-node signaling for mobility between 3rd generation partnership project (3GPP) access networks; idle-mode terminal reachability (including control and execution of paging re-transmission); registration area management; support for intra-system and inter-system mobility; access authentication; access authorization, including roaming permission check; mobility management control (subscription and strategy); support for network slicing; and session management function (SMF) selection.

### 2, Session Management Function (SMF) Network Element

The SMF network element and the AMF network element jointly support a customized mobility management solution, for example, mobile initiated connection only (MICO) or a radio access network (RAN) enhancement function such as a “radio resource control (RRC) inactive” state. The SMF network element can execute tasks such as the following: session management; Internet protocol (IP) address allocation and management of terminals; selection and control of a user plane function (UPF); configuration of traffic control in the UPF to route traffic to appropriate destinations; policy execution and quality of service (QoS) control; and downlink data notification.

### 3, Unified Data Management (UDM) Network Element

The UDM network element is configured to manage user identifiers, subscription data, authentication data, and service network element registration of the user.

Various network elements/functions involved in the embodiments of the present disclosure can be one independent hardware device or functions implemented by computer codes and located in the hardware device, which is not limited in the embodiments of the present disclosure.

In order to better understand a method for determining a transmission configuration indication state disclosed in the embodiments of the present disclosure, a communication system to which the embodiments of the present disclosure is applicable is first described.

A 6th generation mobile communication system (6G) service-oriented architecture abstracts functions of network elements into a plurality of services. Compared with a traditional network architecture, the 6G service-oriented architecture provides various services (such as a sensing service, a computing power service, and an artificial intelligence (AI) service) for the terminal by introducing a synaesthesia fusion technology. The 6G service-oriented architecture includes a network element configured to provide a service, and other network elements in the 6G service-oriented architecture realize deep fusion and mutual enhancement of multidimensional sensing, cooperative communication, and intelligent calculation functions through cooperation and sharing with the network element providing a service. Thus, a network has a capability of intelligent interaction and processing of novel information streams and wide-area intelligent cooperation.

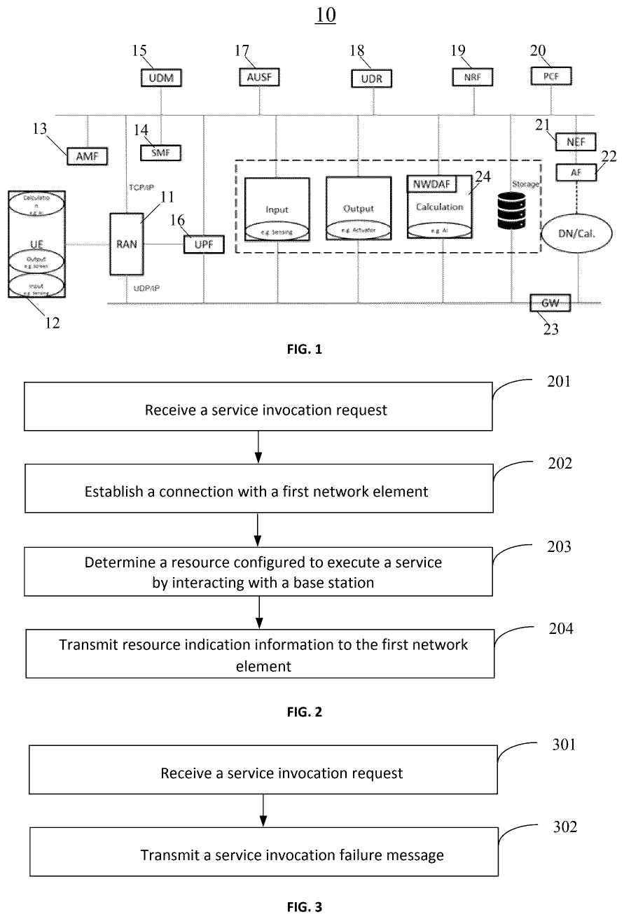

With reference to FIG. 1, a schematic diagram of a 6G service-oriented network architecture 10 according to an embodiment of the present disclosure is shown. FIG. 1 shows network elements and interfaces configured for communication between the network elements in the 6G service-oriented network architecture 10. With reference to FIG. 1, a dotted line box is configured to denote a network element providing a service. As shown in FIG. 1, this type of network elements may realize a sensing capability, an AI calculation capability, etc., and also has a storage capability.

A radio access network (RAN) 11 shown in FIG. 1 can be an entity located on a network side and configured to transmit or receive a signal. For example, the RAN 11 can be an evolved node B (eNB), a transmission reception point (TRP), a next generation node B (gNB) in a new radio (NR) system, a base station in other future mobile communication systems, an access node in a wireless fidelity (WiFi) system, etc. The technology and the device form employed by the network device are not limited in the embodiment of the present disclosure. The network device according to the embodiments of the present disclosure can be composed of a central unit (CU) and a distributed unit (DU). The CU can be referred to as a control unit. With a CU-DU structure, protocol layers of the network device, such as the base station, can be split. Functions of some protocol layers are placed in the CU, so as to be centrally controlled. Functions of part or all of remaining protocol layers are distributed in the DU, and the DU is centrally controlled by the CU.

User equipment (UE) 12 (or referred to as a terminal) shown in FIG. 1 can be an entity located on a user side and configured to receive or transmit a signal, such as a mobile phone. The terminal can be referred to as a terminal, user equipment (UE), a mobile station (MS), a mobile terminal (MT), etc. The terminal can be a vehicle, smart vehicle, mobile phone, wearable device, and pad having a function of communication; and a computer, virtual reality (VR) terminal, augmented reality (AR) terminal, wireless terminal in industrial control, wireless terminal in self-driving, wireless terminal in remote medical surgery, wireless terminal in smart grid, wireless terminal in transportation safety, wireless terminal in smart city, and wireless terminal in smart home having a function of wireless transceiving, etc. The technology and the device form employed by the UE 12 are not limited in the embodiments of the present disclosure.

FIG. 1 further shows network elements such as an AMF 13, an SMF 14, UDM 15, etc. Based on cooperative scheduling by the AMF 13 and the SMF 14, the terminal (i.e. the UE 12 in FIG. 1) can establish a user plane connection with the network element providing a service through the RAN 11. Thus, the network element providing a service can provide a service that the terminal requests to invoke for the terminal. Reference can be made to the description in subsequent embodiments for a flow of this part. Further, FIG. 1 further shows a user plane function (UPF) 16, an authentication server function (AUSF) 17, a user data repository (UDR) 18, a network repository function (NRF) 19, a policy control function (PCF) 20, a network exposure function (NEF) 21, an application function (AF) 22, a GateWay (GW) 23, and a network data analytics function (NWDAF) 24.

It can be understood that the communication system 10 described in the embodiments of the present disclosure is intended to describe the technical solution in the embodiments of the present disclosure more clearly, instead of limiting the technical solution according to the embodiments of the present disclosure. As those of ordinary skill in the art know, with evolution of system architectures and emergence of new service scenarios, the technical solution according to the embodiments of the present disclosure is also applicable to similar technical problems.

A method and device for invoking a service, a device, and a storage medium according to the embodiments of the present disclosure are described in detail below with reference to the accompanying drawings.

FIG. 2 is a schematic flowchart of a method for invoking a service according to an embodiment of the present disclosure. The method is performed by an SMF network element. As shown in FIG. 2, the method for invoking a service may include steps 201 to 204.

Step 201 includes receiving a service invocation request.

In an embodiment of the present disclosure, the service invocation request may be transmitted from an AMF network element to the SMF network element, and the service invocation request at the AMF network element may be determined by the AMF network element based on transmission by a terminal. In an example, the terminal may transmit the service invocation request to the AMF network element through a base station. The AMF network element may forward the received service invocation request to the SMF network element. The service invocation request may be configured to request to invoke a service for the terminal. The service invocation request may indicate at least one of the terminal requesting to invoke a service or a service that the terminal requests to invoke. In an embodiment of the present disclosure, the service invocation request may include at least one of the following:
an identifier of the terminal requesting to invoke the service, for example, a subscription permanent identifier (SUPI) of the terminal requesting to invoke the service;
a public land mobile network identity (PLMN ID) of the terminal requesting to invoke the service;
a service identifier (service ID) of the service that the terminal requests to invoke; or
a service type of the service that the terminal requests to invoke.

In an embodiment of the present disclosure, the service the terminal requests to invoke may include at least one of the following:
a sensing service;
a computing power service; or
an AI service.

Step 202 includes establishing a connection with a first network element.

In an embodiment of the present disclosure, the first network element may be a network element providing the service the terminal requests to invoke. In an embodiment of the present disclosure, the SMF network element receiving the service invocation request indicates that the terminal currently requests to invoke the service. In this case, the SMF network element may establish the connection with the first network element, so that a user plane connection may be established between the first network element and the terminal through subsequent interaction between the SMF network element and the first network element. Further, the first network element may provide the terminal with the service that the terminal requests to invoke by communicating with the terminal through the user plane connection.

Further, in an embodiment of the present disclosure, establishing the connection with the first network element may include step a (not shown) and step b (not shown).

Step a includes requesting to query subscription information of the terminal from unified data management (UDM) network element.

In an embodiment of the present disclosure, the SMF network element may request to query the subscription information of the terminal by transmitting a query request to the UDM network element. The query request may include an identifier of the terminal requesting to invoke the service. Thus, the UDM network element may query the subscription information of the terminal based on the identifier of the terminal.

In an embodiment of the present disclosure, the subscription information may be configured to indicate whether the terminal has permission to invoke the service. In an example, in a case where the UDM network element has queried the subscription information of the terminal, it indicates that the terminal has the permission to invoke the service. In a case where the UDM network element queries no subscription information of the terminal, it indicates that the terminal has no permission to invoke the service. The subscription information may be provided for the UDM network element when the terminal registers in the network.

Step b includes determining the first network element and establishing a session connection with the first network element, in a case where a query result transmitted by the UDM network element indicates that the subscription information of the terminal can be queried.

In an embodiment of the present disclosure, in a case where the query result transmitted by the UDM network element indicates that the subscription information of the terminal can be queried, it indicates that the terminal requesting to invoke the service has the permission to invoke the service. In this case, the SMF network element may determine the first network element that can provide the service that the terminal requests to invoke, and establish the session connection with the first network element.

In an embodiment of the present disclosure, when determining the first network element, the SMF network element may select a network element that can provide the service based on at least one of the service identifier or service type of the service that the terminal requests to invoke, and determine the selected network element as the first network element.

In another embodiment of the present disclosure, the SMF network element may determine the first network element based on the PLMN ID of the terminal requesting to invoke the service. In an example, the SMF network element may first determine a communication location of the terminal based on the PLMN ID of the terminal requesting to invoke the service; and then determine, based on the communication location of the terminal, a network element that is closest to the terminal and can provide the service that the terminal requests to invoke as the first network element. Thus, the first network element is closest to the terminal, so as to ensure communication efficiency between the first network element and the terminal. Further, in a case where the first network element provides the terminal with the service by interacting with the terminal subsequently, execution efficiency of the service can be ensured.

Step 203 includes determining, by interacting with the base station, a resource configured to execute the service.

In an embodiment of the present disclosure, a “resource configured to execute the service” may be interpreted as a communication resource used when the service that the terminal requests to invoke is provided for the terminal.

In an embodiment of the present disclosure, a manner for the SMF network element to determine, by interacting with the base station, the resource configured to execute the service may include step 1 (not shown) and step 2 (not shown).

Step 1 includes transmitting a resource scheduling request to the base station.

In an embodiment of the present disclosure, the resource scheduling request is configured to request the base station to schedule for the terminal the resource configured to execute the service. In a case where the base station receives the resource scheduling request, the resource configured to execute the service may be scheduled for the terminal based on the resource scheduling request.

Further, it is to be noted that in an embodiment of the present disclosure, in a case where the service that the terminal requests to invoke is provided for the terminal subsequently, the first network element provides the service that the terminal requests to invoke for the terminal by interacting with the terminal through the base station. Thus, the “resource configured to execute the service” may be an interaction resource between the first network element and the terminal. In view of this case, in an embodiment of the present disclosure, the resource scheduling request may include an identifier of the first network element. After receiving the resource scheduling request, the base station may schedule, based on the identifier of the first network element, for the terminal the resource configured to execute the service. For example, a communication location of the first network element may be determined based on the identifier of the first network element, and a resource that can enable high communication efficiency between the first network element and the terminal may be scheduled as the resource configured to execute the service based on at least one of the communication location of the first network element or the communication location of the terminal. Thus, communication efficiency between the first network element and the terminal is ensured. Further, in a case where the first network element provides the service that the terminal requests to invoke for the terminal by interacting with the terminal, execution efficiency of the service can be ensured.

Step 2 includes receiving resource indication information transmitted by the base station, where the resource indication information indicates the resource scheduled by the base station for the terminal and configured to execute the service.

The SMF network element interacts with the base station by executing the steps 1 and 2, so as to determine the resource configured to execute the service.

Step 204 includes transmitting the resource indication information to the first network element.

In an embodiment of the present disclosure, the resource indication information indicates the resource configured to execute the service, and the resource indication information may be configured for the first network element to establish a user plane connection with the terminal based on the resource indication information. In an embodiment of the present disclosure, after establishing the user plane connection with the terminal, the first network element may provide the terminal with the service that the terminal requests to invoke by performing communication interaction with the terminal.

In the method for invoking a service provided by the present disclosure, the SMF network element receives the service invocation request, where the service invocation request indicates at least one of the terminal requesting to invoke the service or the service that the terminal requests to invoke; establishes the connection with the first network element, where the first network element is the network element providing the service that the terminal requests to invoke; then determines the resource configured to execute the service by interacting with the base station; and finally transmits the resource indication information to the first network element, where the resource indication information indicates the resource configured to execute the service, and the resource indication information is configured for the first network element to establish the user plane connection with the terminal based on the resource indication information. In this way, the method for invoking a service according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

FIG. 3 is a schematic flowchart of a method for invoking a service according to an embodiment of the present disclosure. The method is performed by an SMF network element. As shown in FIG. 3, the method for invoking a service may include steps 301 and 302.

Step 301 includes receiving a service invocation request, where the service invocation request indicates at least one of a terminal requesting to invoke a service or a service that the terminal requests to invoke.

Reference can be made to the description in the embodiments of the disclosure for the relevant description of step 301.

Step 302 includes transmitting a service invocation failure message.

In an embodiment of the present disclosure, in a case where the SMF network element determines that the terminal requesting to invoke the service has no permission to invoke the service, the SMF network element transmits the service invocation failure message to an AMF network element. The AMF network element transmits the service invocation failure message to the terminal, so as to inform the terminal that the terminal cannot invoke the service that the terminal requests to invoke.

In an embodiment of the present disclosure, the SMF network element determining that the terminal requesting to invoke the service has no permission to invoke the service may include: receiving, by the SMF network element, a query result transmitted by a UDM network element and indicating that no subscription information of the terminal is queried. Reference can be made to the embodiment of the disclosure for the content of this part, which will not be repeated here.

In the method for invoking a service provided by the present disclosure, the SMF network element receives the service invocation request, where the service invocation request indicates at least one of the terminal requesting to invoke the service or the service that the terminal requests to invoke; and in a case of determining that the terminal requesting to invoke the service has no permission to invoke the service, the SMF network element transmits the service invocation failure message. In this way, the method for invoking a service according to the present disclosure may cause the terminal to invoke the service from a network.

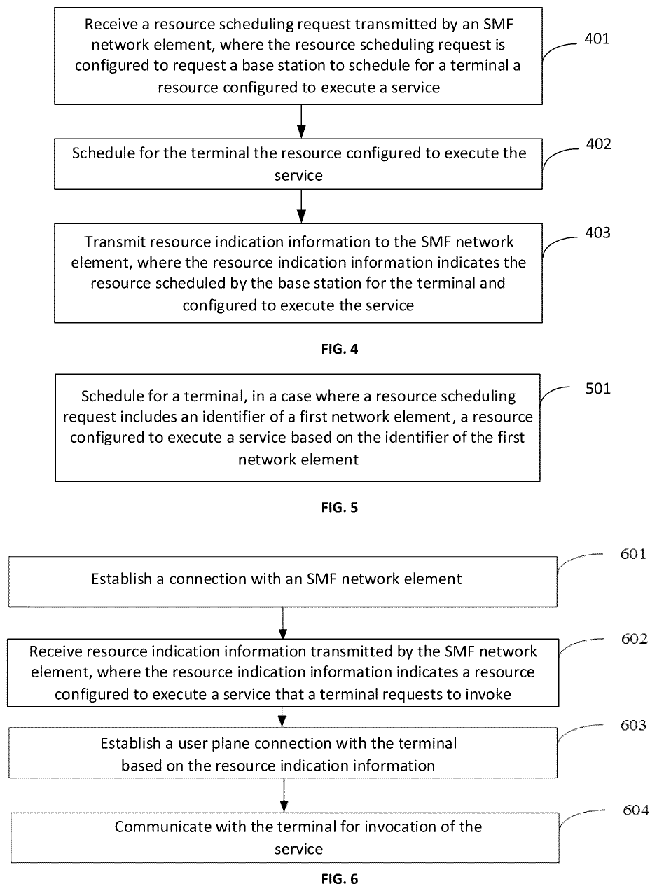

FIG. 4 is a schematic flowchart of a method for invoking a service according to an embodiment of the present disclosure. The method is performed by a base station. As shown in FIG. 4, the method for invoking a service may include steps 401, 402, and 403.

Step 401 includes receiving a resource scheduling request transmitted by an SMF network element, where the resource scheduling request is configured to request the base station to schedule for a terminal a resource configured to execute a service.

Step 402 includes scheduling the resource configured to execute the service for the terminal.

Step 403 includes transmitting resource indication information to the SMF network element, where the resource indication information indicates the resource scheduled by the base station for the terminal and configured to execute the service.

In an embodiment of the present disclosure, the base station transmits the resource indication information to the SMF network element, and the SMF network element may transmit the resource indication information to the first network element. The first network element establishes a connection with the terminal based on the resource indication information, so as to provide the service that the terminal requests to invoke for the terminal.

Reference can be made to the description in the embodiments of the disclosure for other detailed description of steps 401-403.

In the method for invoking a service provided by the present disclosure, the base station receives the resource scheduling request transmitted by the SMF network element, where the resource scheduling request is configured to request the base station to schedule for the terminal the resource configured to execute the service; then schedules the resource configured to execute the service for the terminal; and finally transmits the resource indication information to the SMF network element, where the resource indication information indicates the resource scheduled by the base station for the terminal and configured to execute the service. In this way, the method for invoking a service according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

FIG. 5 is a schematic flowchart of a method for invoking a service according to an embodiment of the present disclosure. The method is performed by a base station. As shown in FIG. 5, the method for invoking a service may include step 501.

Step 501 includes scheduling, in a case where the resource scheduling request includes an identifier of the first network element, the resource configured to execute the service for the terminal based on the identifier of the first network element.

In an example, the base station may determine a communication location of the first network element based on the identifier of the first network element; and schedule, based on at least one of the communication location of the first network element or a communication location of the terminal, a resource that can enable high communication efficiency between the first network element and the terminal as the resource configured to execute the service. Thus, communication efficiency between the first network element and the terminal is ensured. Further, in a case where the first network element provides the service that the terminal requests to invoke for the terminal by interacting with the terminal, execution efficiency of the service can be ensured.

Reference can be made to the description in the embodiments of the disclosure for other detailed descriptions of step 501.

In the method for invoking a service provided by the present disclosure, the base station schedules the resource configured to execute the service for the terminal based on the identifier of the first network element in a case where the resource scheduling request includes the identifier of the first network element. Thus, the resource that can enable the high communication efficiency between the first network element and the terminal may be scheduled as the resource configured to execute the service. Accordingly, interaction efficiency between the first network element and the terminal can be ensured. Further, in a case where the first network element provides the service that the terminal requests to invoke for the terminal by interacting with the terminal, the execution efficiency of the service can be ensured.

FIG. 6 is a schematic flowchart of a method for invoking a service according to an embodiment of the present disclosure. The method is performed by a first network element. As shown in FIG. 6, the method for invoking a service may include steps 601, 602, 603, and 604.

Step 601 includes establishing a connection with an SMF network element.

Step 602 includes receiving resource indication information transmitted by the SMF network element, where the resource indication information indicates a resource configured to execute a service that a terminal requests to invoke.

Step 603 includes establishing a user plane connection with the terminal based on the resource indication information.

In an embodiment of the present disclosure, establishing the user plane connection with the terminal based on the resource indication information may include: establishing the user plane connection with the terminal through the base station based on the resource indicated by the resource indication information.

Step 604 includes communicating with the terminal for invocation of the service.

In an example, after establishing the user plane connection with the terminal, the first network element may perform user plane communication with the terminal. For example, the first network element may perform the user plane communication with the terminal through the base station, so as to provide the service that the terminal requests to invoke for the terminal.

Reference can be made to the description in the embodiments of the disclosure for the detailed descriptions of steps 601-604.

In the method for invoking a service provided by the present disclosure, the first network element establishes the connection with the SMF network element; receives the resource indication information transmitted by the SMF network element, where the resource indication information indicates the resource configured to execute the service that the terminal requests to invoke; then establishes the user plane connection with the terminal based on the resource indication information; and finally communicates with the terminal for invocation of the service. In this way, the method for invoking a service according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

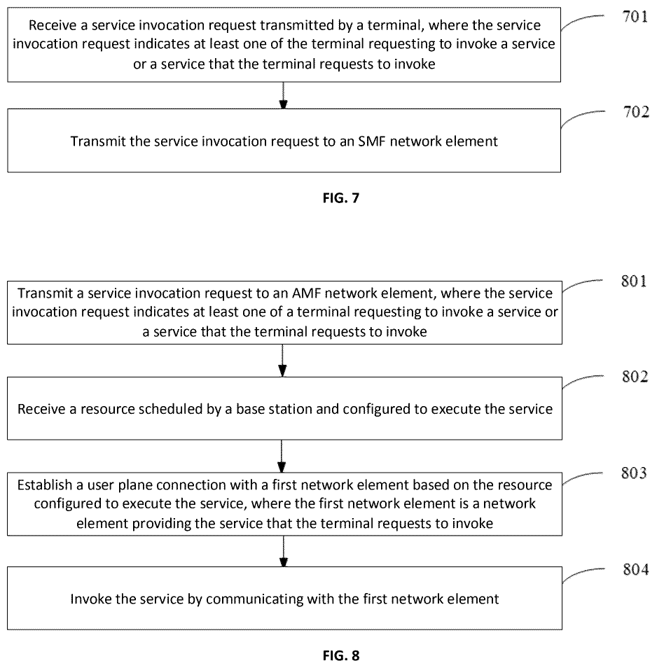

FIG. 7 is a schematic flowchart of a method for invoking a service according to an embodiment of the present disclosure. The method is performed by an AMF network element. As shown in FIG. 7, the method for invoking a service may include steps 701 and 702.

Step 701 includes receiving a service invocation request transmitted by a terminal, where the service invocation request indicates at least one of the terminal requesting to invoke a service or a service that the terminal requests to invoke.

Step 702 includes transmitting the service invocation request to an SMF network element.

Reference can be made to the description in the embodiments of the disclosure for the detailed descriptions of steps 701-702.

In the method for invoking a service provided by the present disclosure, the AMF network element receives the service invocation request transmitted by the terminal, where the service invocation request indicates at least one of the terminal requesting to invoke the service or the service that the terminal requests to invoke; and then transmits the service invocation request to the SMF network element. In this way, the method for invoking a service according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

FIG. 8 is a schematic flowchart of a method for invoking a service according to an embodiment of the present disclosure. The method is performed by a terminal. As shown in FIG. 8, the method for invoking a service may include steps 801, 802, 803, and 804.

Step 801 includes transmitting a service invocation request to an AMF network element, where the service invocation request indicates at least one of the terminal requesting to invoke a service or a service that the terminal requests to invoke.

Step 802 includes receiving a resource scheduled by a base station and configured to execute the service.

Step 803 includes establishing a user plane connection with a first network element based on the resource configured to execute the service, where the first network element is a network element providing the service that the terminal requests to invoke.

In an embodiment of the present disclosure, establishing the user plane connection with the first network element based on the resource configured to execute the service may include: establishing the user plane connection with the first network element through the base station based on the resource configured to execute the service.

Step 804 includes invoking the service by communicating with the first network element.

In an example, after establishing the user plane connection with the first network element, the terminal may perform user plane communication with the first network element. For example, the terminal may perform the user plane communication with the first network element through the base station. Thus, the first network element may provide the service that the terminal requests to invoke for the terminal.

Reference can be made to the description in the embodiments of the disclosure for the detailed descriptions of steps 801-804.

In the method for invoking a service provided by the present disclosure, the terminal transmits the service invocation request to the AMF network element, where the service invocation request indicates at least one of the terminal requesting to invoke the service or the service that the terminal requests to invoke; then receives the resource scheduled by the base station and configured to execute the service; establishes the user plane connection with the first network element based on the resource configured to execute the service, where the first network element is the network element providing the service that the terminal requests to invoke; and finally invokes the service by communicating with the first network element. In this way, the method for invoking a service according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

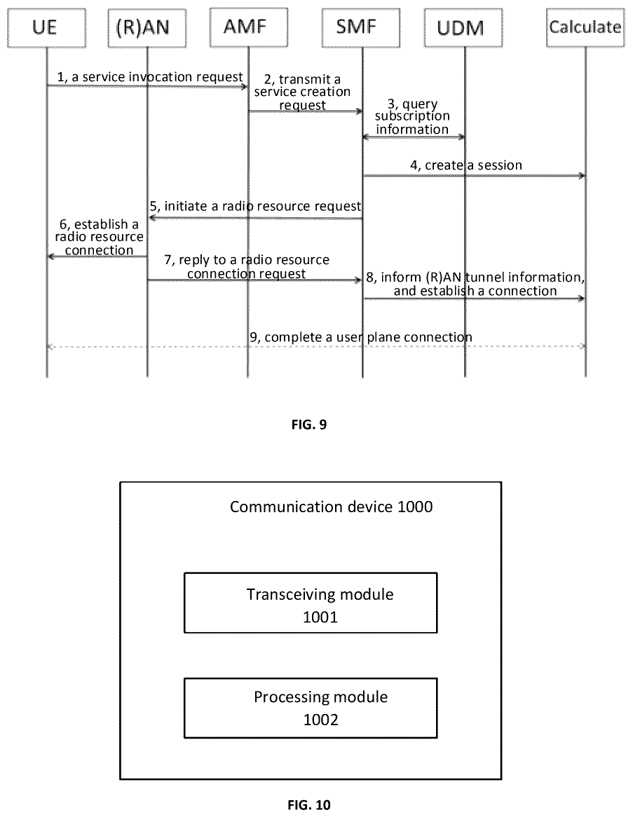

Based on the above-mentioned descriptions, FIG. 9 is an interaction method for invoking a service according to an embodiment of the present disclosure. UE in FIG. 9 is the terminal, and a calculate unit in FIG. 9 is the first network element. As shown in FIG. 9, the interaction method may include steps 1 to 9.

Step 1 includes pre-invoking, by the terminal, a sensing service and a computing power service of a core network; transmitting service creation request information (i.e. the service invocation request in the above-mentioned embodiments) to the core network through an (R)AN (i.e. the base station in the above-mentioned embodiments), where the service creation request information includes an identifier (SUPI, etc.), a PLMN ID, a cal service ID, and a cal service type of the terminal, etc. ; and transmitting, by the RAN, the service creation request information to the AMF.

Step 2 includes transmitting, by the AMF, the received service creation request information to the SMF.

Step 3 includes acquiring, by the SMF, subscription information of the UE from the UDM after receiving the service creation request information, and returning, by the UDM, a query result to the SMF.

In a case where no subscription information of the UE is queried at the UDM, a service creation failure message is returned.

In a case where the subscription information of the UE is queried at the UDM, a query success result is returned by the UDM to the SMF, and the service is created by the SMF subsequently.

Step 4 includes establishing, by the SMF after receiving the query result, a user plane connection by establishing a session with a calculate unit.

Step 5 includes initiating, by the SMF, a radio resource request (i.e. the resource scheduling request in the above-mentioned embodiments) to the (R)AN.

Step 6 includes setting, by the (R)AN after receiving the radio resource request, a corresponding radio resource for the terminal (i.e. scheduling the resource configured to execute the service for the terminal in the above-mentioned embodiments).

Step 7 includes replying to, by the (R)AN, the radio resource request of the SMF (i.e. the resource indication information in the above-mentioned embodiments).

Step 8 includes informing, by the SMF after receiving the reply, the calculate unit (i.e. the first network element in the above-mentioned embodiments) of (R)AN tunnel information (i.e. the resource indication information in the above-mentioned embodiments), so as to establish a tunnel between the calculate unit and the (R)AN (i.e. the communication connection between the first network element and the base station in the above-mentioned embodiments).

Step 9 includes completing the user plane connection among the terminal, the R(AN), the calculate unit of the core network (i.e. the first network element in the above-mentioned embodiments). The terminal directly interacts with the calculate unit of the core network through the user plane connection subsequently.

Thus, the present disclosure arranges and fuses a sensing function, a calculation function, and an AI function into a significant constituent module of a novel computing power network by designing a novel 6G AI network architecture, and designs a creation request flow for the terminal to invoke the sensing service and the computing power service of the core network.

FIG. 10 is a schematic structural diagram of a communication device according to an embodiment of the present disclosure. The communication device 1000 may be configured in an SMF network element. As shown in FIG. 10, the communication device 1000 may include a transceiving module 1001 and a processing module 1002.

The transceiving module 1001 is configured to receive a service invocation request, where the service invocation request indicates at least one of a terminal requesting to invoke a service or a service that the terminal requests to invoke.

The processing module 1002 is configured to establish a connection with a first network element, where the first network element is a network element providing the service that the terminal requests to invoke.

The transceiving module 1001 is further configured to determine a resource configured to execute the service by interacting with a base station.

The transceiving module 1001 is further configured to transmit resource indication information to the first network element, where the resource indication information indicates the resource configured to execute the service, and the resource indication information is configured for the first network element to establish a user plane connection with the terminal based on the resource indication information.

In the communication device 1000 according to the embodiments of the present disclosure, the SMF network element receives the service invocation request, where the service invocation request indicates at least one of the terminal requesting to invoke the service or the service that the terminal requests to invoke; establishes the connection with the first network element, where the first network element is the network element providing the service that the terminal requests to invoke; then determines the resource configured to execute the service by interacting with the base station; and finally transmits the resource indication information to the first network element, where the resource indication information indicates the resource configured to execute the service, and the resource indication information is configured for the first network element to establish the user plane connection with the terminal based on the resource indication information. In this way, the communication device 1000 according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

In an embodiment of the present disclosure, the service invocation request may include at least one of the following:
an identifier of the terminal requesting to invoke the service;
a PLMN ID of the terminal requesting to invoke the service;
a service ID of the service that the terminal requests to invoke; or
a service type of the service that the terminal requests to invoke.

In an embodiment of the present disclosure, the service the terminal requests to invoke may include at least one of the following:
a sensing service;
a computing power service; or
an AI service.

In an embodiment of the present disclosure, the transceiving module 1001 is further configured to:
receive the service invocation request transmitted by an AMF network element, where the service invocation request at the AMF network element is determined by the AMF network element based on transmission by the terminal.

In an embodiment of the present disclosure, the processing module 1002 is further configured to:
request to query subscription information of the terminal from a UDM network element; and
determine the first network element and establish a session connection with the first network element, in a case where a query result transmitted by the UDM network element indicates that the subscription information of the terminal is queried.

In an embodiment of the present disclosure, the processing module 1002 is further configured to:
determine the corresponding first network element based on the service that the terminal requests to invoke.

In an embodiment of the present disclosure, the communication device 1000 is further configured to:
transmit a service invocation failure message in a case where the query result transmitted by the UDM network element indicates that no subscription information of the terminal is queried.

In an embodiment of the present disclosure, the transceiving module 1001 is further configured to:
transmit a resource scheduling request to a base station, where the resource scheduling request is configured to request the base station to schedule for the terminal a resource configured to execute the service; and
receive resource indication information transmitted by the base station, where the resource indication information indicates the resource scheduled by the base station for the terminal and configured to execute the service.

In an embodiment of the present disclosure, the resource scheduling request includes an identifier of the first network element, and the resource scheduling request is configured to request the base station to schedule, based on the identifier of the first network element, for the terminal the resource configured to execute the service.

FIG. 11 is a schematic structural diagram of a communication device according to an embodiment of the present disclosure. The communication device 1100 may be configured in a base station. As shown in FIG. 11, the communication device 1100 may include a transceiving module 1101 and a processing module 1102.

The transceiving module 1101 is configured to receive a resource scheduling request transmitted by an SMF network element, where the resource scheduling request is configured to request the base station to schedule for a terminal a resource configured to execute a service.

The processing module 1102 is configured to schedule for the terminal the resource configured to execute the service.

The transceiving module 1101 is further configured to transmit resource indication information to the SMF network element, where the resource indication information indicates the resource scheduled by the base station for the terminal and configured to execute the service.

In the communication device 1100 according to the embodiments of the present disclosure, the base station receives the resource scheduling request transmitted by the SMF network element, where the resource scheduling request is configured to request the base station to schedule for the terminal the resource configured to execute the service; then schedules the resource configured to execute the service for the terminal; and finally transmits the resource indication information to the SMF network element, where the resource indication information indicates the resource scheduled by the base station for the terminal and configured to execute the service. In this way, the communication device 1100 according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

In an embodiment of the present disclosure, the resource scheduling request includes an identifier of the first network element; and
the processing module 1102 is further configured to schedule, based on the identifier of the first network element, for the terminal the resource configured to execute the service.

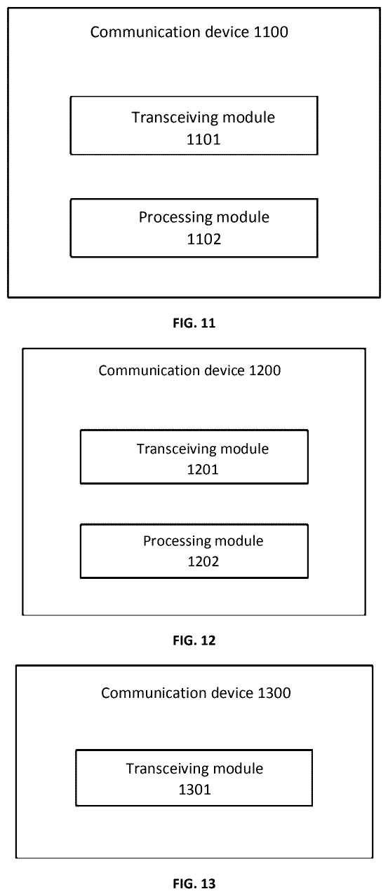

FIG. 12 is a schematic structural diagram of a communication device according to an embodiment of the present disclosure. The communication device 1200 may be configured in a first network element. As shown in FIG. 12, the communication device 1200 may include a transceiving module 1201 and a processing module 1202.

The processing module 1202 is configured to establish a connection with an SMF network element.

The transceiving module 1201 is configured to receive resource indication information transmitted by the SMF network element, where the resource indication information indicates a resource configured to execute a service that a terminal requests to invoke.

The processing module 1202 is further configured to establish a user plane connection with the terminal based on the resource indication information.

The transceiving module 1201 is further configured to communicate with the terminal for invocation of the service.

In the communication device 1200 according to the embodiments of the present disclosure, the first network element establishes the connection with the SMF network element; receives the resource indication information transmitted by the SMF network element, where the resource indication information indicates the resource configured to execute the service that the terminal requests to invoke; then establishes the user plane connection with the terminal based on the resource indication information; and finally communicates with the terminal for invocation of the service. In this way, the communication device 1200 according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

FIG. 13 is a schematic structural diagram of a communication device according to an embodiment of the present disclosure. The communication device 1300 may be configured in an AMF network element. As shown in FIG. 13, the communication device 1300 may include a transceiving module 1301.

The transceiving module 1301 is configured to receive a service invocation request transmitted by a terminal, where the service invocation request indicates at least one of the terminal requesting to invoke a service or a service that the terminal requests to invoke.

The transceiving module 1301 is further configured to transmit the service invocation request to an SMF network element.

In the communication device 1300 according to the embodiments of the present disclosure, the AMF network element receives the service invocation request transmitted by the terminal, where the service invocation request indicates at least one of the terminal requesting to invoke the service or the service that the terminal requests to invoke; and then transmits the service invocation request to the SMF network element. In this way, the communication device 1300 according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

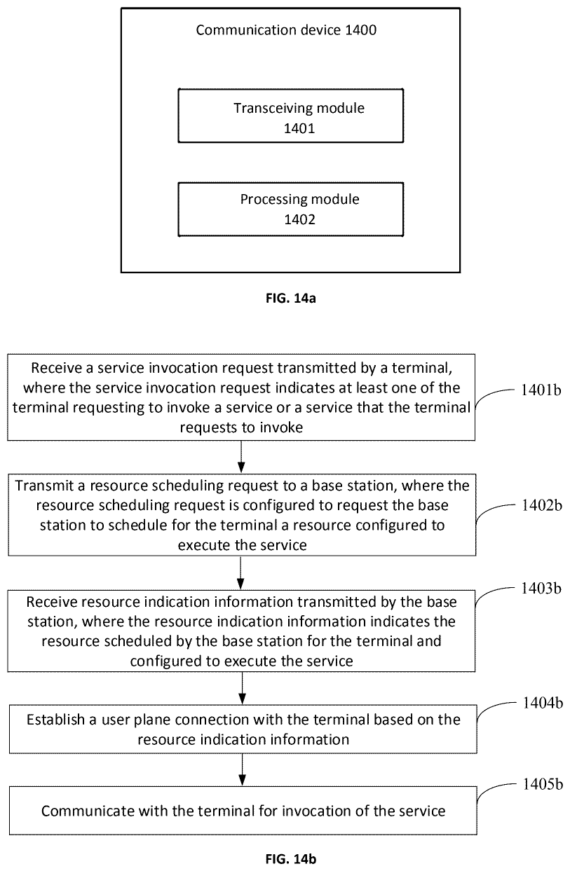

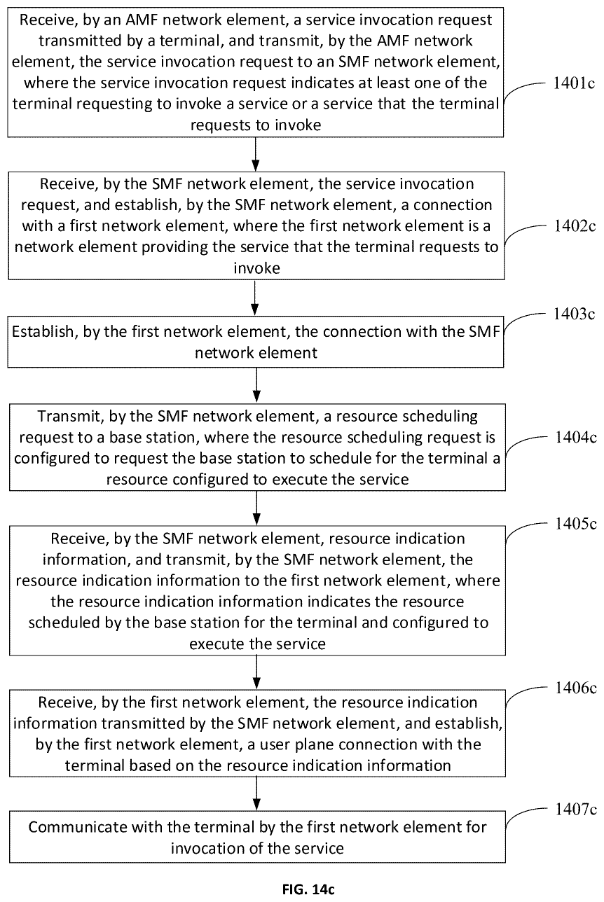

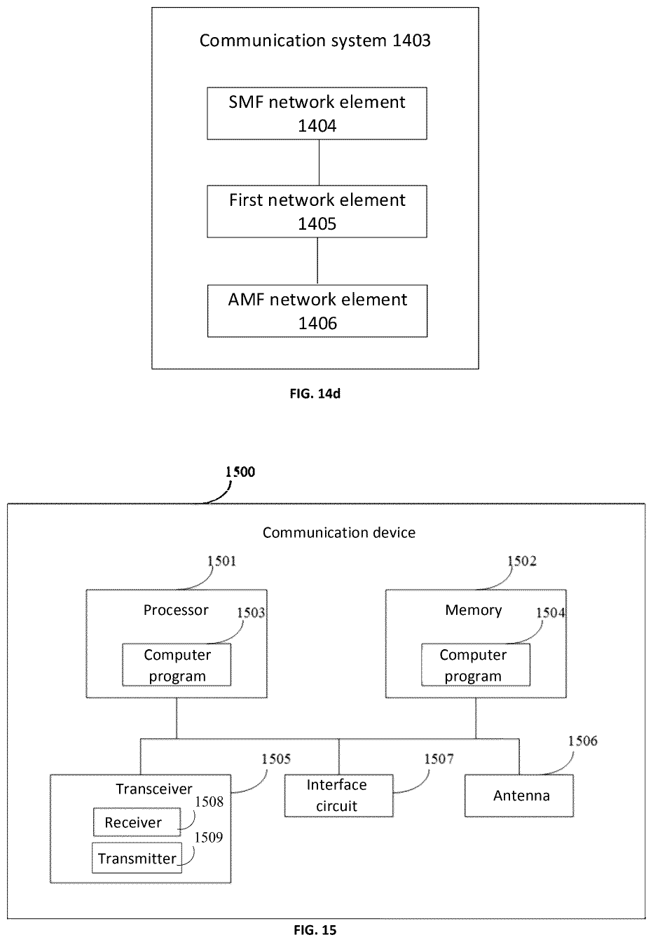

FIG. 14a is a schematic structural diagram of a communication device according to an embodiment of the present disclosure. The communication device 1400 may be configured in a terminal. As shown in FIG. 14a, the communication device 1400 may include a transceiving module 1401 and a processing module 1402.

The transceiving module 1401 is configured to transmit a service invocation request to an AMF network element, where the service invocation request indicates at least one of the terminal requesting to invoke a service or a service that the terminal requests to invoke.

The transceiving module 1401 is further configured to receive a resource scheduled by a base station and configured to execute the service.

The processing module 1402 is configured to establish a user plane connection with a first network element based on the resource configured to execute the service, where the first network element is a network element providing the service that the terminal requests to invoke.

The transceiving module 1401 is further configured to invoke the service by communicating with the first network element.

In the communication device 1400 according to the embodiments of the present disclosure, the terminal transmits the service invocation request to the AMF network element, where the service invocation request indicates at least one of the terminal requesting to invoke the service or the service that the terminal requests to invoke; then receives the resource scheduled by the base station and configured to execute the service; establishes the user plane connection with the first network element based on the resource configured to execute the service, where the first network element is the network element providing the service that the terminal requests to invoke; and finally invokes the service by communicating with the first network element. In this way, the communication device 1400 according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

FIG. 14b is a schematic flowchart of a communication method according to an embodiment of the present disclosure. The communication method is performed by a core network device. As shown in FIG. 14b, the communication method may include steps 1401b, 1402b, 1403b, 1404b, and 1405b.

Step 1401b includes receiving a service invocation request transmitted by a terminal, where the service invocation request indicates at least one of the terminal requesting to invoke a service or a service that the terminal requests to invoke.

Step 1402b includes transmitting a resource scheduling request to a base station, where the resource scheduling request is configured to request the base station to schedule for the terminal a resource configured to execute the service.

Step 1403b includes receiving resource indication information transmitted by the base station, where the resource indication information indicates the resource scheduled by the base station for the terminal and configured to execute the service.

Step 1404b includes establishing a user plane connection with the terminal based on the resource indication information.

Step 1405b includes communicating with the terminal for invocation of the service.

Reference can be made to the relevant description in the embodiments of the disclosure for the detailed descriptions of other contents in this embodiment, which will not be repeated here.

In the communication method according to the embodiments of the present disclosure, the core network device receives the service invocation request, where the service invocation request indicates at least one of the terminal requesting to invoke the service or the service that the terminal requests to invoke; then transmits the resource scheduling request to the base station, where the resource scheduling request is configured to request the base station to schedule for the terminal the resource configured to execute the service; receives the resource indication information transmitted by the base station, where the resource indication information indicates the resource scheduled by the base station for the terminal and configured to execute the service; establishes the user plane connection with the terminal based on the resource indication information; and finally communicates with the terminal for invocation of the service. In this way, the communication method according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

In an example, the present disclosure further provides a communication system. The communication system (not shown) may be configured to perform the method shown in FIG. 14b.

FIG. 14c is a schematic flowchart of a communication method according to an embodiment of the present disclosure. As shown in FIG. 14c, the communication method may include steps 1401c to 1407c.

Step 1401c includes receiving, by an AMF network element, a service invocation request transmitted by a terminal, and transmitting, by the AMF network element, the service invocation request to an SMF network element, where the service invocation request indicates at least one of the terminal requesting to invoke a service or a service that the terminal requests to invoke.

Step 1402c includes receiving, by the SMF network element, the service invocation request, and establishing, by the SMF network element, a connection with a first network element, where the first network element is a network element providing the service that the terminal requests to invoke.

Step 1403c includes establishing, by the first network element, the connection with the SMF network element.

Step 1404c includes transmitting, by the SMF network element, a resource scheduling request to a base station, where the resource scheduling request is configured to request the base station to schedule for the terminal a resource configured to execute the service.

Step 1405c includes receiving, by the SMF network element, resource indication information, and transmitting, by the SMF network element, the resource indication information to the first network element, where the resource indication information indicates the resource scheduled by the base station for the terminal and configured to execute the service.

Step 1406c includes receiving, by the first network element, the resource indication information transmitted by the SMF network element, and establishing, by the first network element, a user plane connection with the terminal based on the resource indication information.

Step 1407c includes communicating with the terminal by the first network element for invocation of the service.

Reference can be made to the relevant description in the embodiments of the disclosure for the detailed descriptions of other contents in this embodiment, which will not be repeated here.

The communication method according to the present disclosure may cause the user plane connection between the terminal and the first network element to be established, and cause the first network element to provide the service that the terminal requests to invoke for the terminal by communicating with the terminal. Thus, the terminal may invoke a service from a network, providing a more personalized service for a user.

FIG. 14d is a schematic structural diagram of a communication system according to an embodiment of the present disclosure. As shown in FIG. 14d, the communication system 1403 may include:
an SMF network element 1404 configured to perform the method shown in FIGS. 2 and 3;
a first network element 1405 configured to perform the method shown in FIG. 6, where the first network element is a network element providing a service that a terminal requests to invoke; and
an AMF network element 1406 configured to perform the method shown in FIG. 7.

With reference to FIG. 15, a schematic structural diagram of a communication device 1500 according to an embodiment of the present disclosure is shown. The communication device 1500 can be a network device; a terminal; a chip, a chip system, a processor, etc. that supports the network device in implementing the method of the disclosure; or a chip, a chip system, a processor, etc. that supports the terminal in implementing the method of the disclosure. The communication device 1500 can be configured to implement the method described in the method embodiments of the disclosure. Reference can be made to the description in the method embodiments for details.

The communication device 1500 can include one or more processors 1501. The processor 1501 can be a general-purpose processor, a special-purpose processor, etc. For example, the processor 1501 can be a baseband processor or a central processing unit. The baseband processor can be configured to process communication protocols and communication data. The central processing unit can be configured to control the communication device 1500 (such as a base station, a baseband chip, a terminal, a terminal chip, a DU, and a CU), execute a computer program, and process data of the computer program.

The communication device 1500 can further include one or more memories 1502, where the memory 1502 stores a computer program 1504. The processor 1501, when executing the computer program 1504, causes the communication device 1500 to perform the method described in the method embodiment. In an example, the memory 1502 can further store data. The communication device 1500 and the memory 1502 can be arranged separately or integrated together.

The communication device 1500 can further include a transceiver 1505 and an antenna 1506. The transceiver 1505 can be referred to as a transceiving unit, a transceiving machine, a transceiving circuit, etc., and configured to implement a function of transceiving. The transceiver 1505 can include a receiver 1508 and a transmitter 1509. The receiver 1508 can be referred to as a reception machine, a reception circuit, etc., and configured to implement a function of reception. The transmitter 1509 can be referred to as a transmission machine, a transmission circuit, etc., and configured to implement a function of transmission.

The communication device 1500 can further include one or more interface circuits 1507. The interface circuit 1507 is configured to receive code instructions, and transmit the code instructions to the processor 1501. The processor 1501, when running the code instructions, causes the communication device 1500 to perform the method described in the method embodiment.

In an implementation, the processor 1501 can include a transceiver (not shown) configured to implement functions of reception and transmission. For example, the transceiver can be a transceiving circuit, an interface, or an interface circuit. The transceiving circuit, interface, or interface circuit configured to implement the functions of reception and transmission can be separated or integrated together. The transceiving circuit, interface, or interface circuit can be configured to read and write codes/data. Alternatively, the transceiving circuit, interface, or interface circuit can be configured to transmit or transfer a signal.

In an implementation, the processor 1501 can store a computer program 1503. The computer program 1503, when running in the processor 1501, causes the communication device 1500 to perform the method described in the method embodiment. The computer program 1503 may be firmed in the processor 1501. In this case, the processor 1501 may be implemented by hardware.

In an implementation, the communication device 1500 can include a circuit (not shown), where the circuit can implement the function of transmission, reception, or communication in the method embodiment. The processor and the transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver can be fabricated through various IC process technologies, such as a complementary metal oxide semiconductor (CMOS), an nmetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device 1500 described in the embodiment of the disclosure can be a network device or a terminal, but which is not intended to limit the scope of the communication device 1500 described in the present disclosure. The structure of the communication device 1500 may not be limited by FIG. 15. The communication device 1500 can be a stand-alone device or a part of a large device. For example, the communication device 1500 can be:
(1) an independent integrated circuit (IC), a chip, a chip system, or a chip sub-system;
(2) a set having one or more ICs, which can include a storage component configured to store data and computer programs;
(3) an ASIC, such as a modem;
(4) a module, which can be embedded in other devices;
(5) a reception machine, a terminal, a smart terminal, a cellular phone, a radio device, a handset, a mobile unit, a vehicle-mounted device, a network device, a cloud device, an artificial intelligence device, etc. ; and
(6) other device, etc.

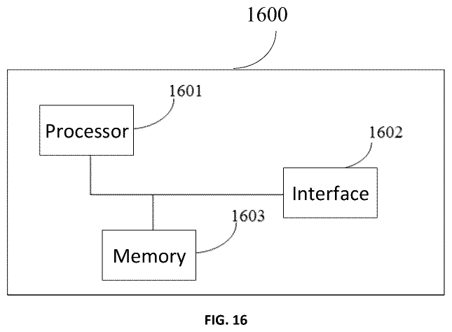

Reference can be made to the schematic structural diagram of a chip shown in FIG. 16 for the case where the communication device can be the chip or chip system. The chip 1600 shown in FIG. 16 includes a processor 1601 and an interface 1602. One or more processors 1601 can be provided, and a plurality of interfaces 1602 can be provided.

The chip 1600 may further include a memory 1603, where the memory 1603 is configured to store the necessary computer program and data.

Those skilled in the art can also appreciate that various illustrative logical blocks and steps set forth in the embodiments of the present disclosure can be implemented through electronic hardware, computer software, or their combinations. Whether such functions are implemented through the hardware or the software depends on the particular application and overall system design requirements. Those skilled in the art can implement the functions through various methods for each particular application, but such an implementation is not interpreted as falling beyond the scope of protection of the embodiments of the present disclosure.

The present disclosure further provides a non-transitory computer-readable storage medium. The non-transitory computer-readable storage medium stores instructions. The instructions, when executed by a computer, implement the functions in any method embodiment described in the disclosure.

The present disclosure further provides a computer program product. The computer program product, when executed by a computer, implements the functions in any method embodiment described in the disclosure.

In the embodiments, some or all of the functions can be implemented through software, hardware, firmware, or their any combinations. When implemented through the software, some or all of the functions can be implemented in a form of a computer program product. The computer program product includes one or more computer programs. Some or all of the computer programs, when loaded and executed in the computer, generate the flows or functions according to the embodiments of the present disclosure. The computer can be a general-purpose computer, a special-purpose computer, a computer network, or another programmable device. The computer program can be stored in a non-transitory computer-readable storage medium, or transmitted from one computer-readable storage medium to another non-transitory computer-readable storage medium, for example, from one website, computer, server, or data center to another website, computer, server, or data center through a wired means (for example, a coaxial cable, an optical fiber, and a digital subscribe line (DSL)), or a wireless means (for example, infrared, radio waves, and microwaves). The non-transitory computer-readable storage medium can be any available medium that a computer can access, or an integrated server, data center, etc. encompassing one or more available media. The available medium can be a magnetic medium (for example, a floppy disk, a hard disk, and a tape), an optical medium (for example, a digital video disc (DVD)), a semiconductor medium (for example, a solid state disk (SSD)), etc.

As used herein, the term “processor” may refer to one processor that performs the defined functions or a plurality of processors that collectively perform defined functions, such that the execution of the individual defined functions may be divided amongst such processors.

Those of ordinary skill in the art can understand that various numerical numbers such as first and second involved in the present disclosure are merely for convenience of description, instead of limiting the scope of the embodiments of the present disclosure, and also indicate a sequential order.

The term “at least one” in the present disclosure can be described as one or more, and the term “a plurality of” can indicate two, three, four, or more, which is not limited in the present disclosure. In the embodiments of the present disclosure, for a technical feature, technical features in the technical feature are distinguished with “first,” “second,” “third,” “A,” “B,” “C” and “D”, and no sequential order or size order is indicated among the technical features described with “first,” “second,” “third,” “A,” “B,” “C,” and “D”.

Correspondence relations shown in each table of the present disclosure can be configured or pre-defined. Values of information in each table are merely illustrative, and can be configured as other values, which is not limited in the present disclosure. When a correspondence relation between the information and each parameter is configured, it is not necessarily required to configure all the correspondence relations indicated in each table. For example, in the table of the present disclosure, the corresponding relations shown in some rows may not be configured. For another example, appropriate variation and adjustment, such as splitting and merging, can be made based on the table. The name of the parameter shown in the title of each table can employ other names that are understandable by the communication device, and the value or expression mode of the parameter can employ other values or expression modes that are understandable by the communication device. When implemented, each table can employ other data structures, such as an array, a queue, a container, a stack, a linear table, a pointer, a linked list, a tree, a graph, a structural body, a class, a heap, and a hash table.

The wording “pre-defining” in the present disclosure can be interpreted as defining, pre-defining, storing, pre-storing, pre-negotiating, pre-configuring, firming, or pre-firing.

Those of ordinary skill in the art can appreciate that the units and algorithm steps in all instances described in combination with the embodiments disclosed in the disclosure can be implemented through electronic hardware, or combinations of computer software and electronic hardware. Whether the functions are executed through hardware or software depends on particular applications and design constraint conditions of the technical solution. Those skilled in the art can implement the functions described through different methods for each particular application, but such an implementation is not deemed as falling beyond the scope of the present disclosure.

Those skilled in the art can clearly understand that for convenience and brevity of description, reference can be made to the corresponding processes in the method embodiments for operation processes of the system, device, and unit, which will not be repeated here.

What are described are merely the particular implementations of the present disclosure, and are not intended to limit the scope of protection of the present disclosure. Changes or substitutions that can be readily conceived by those skilled in the art within the technical scope disclosed by the present disclosure should fall within the scope of protection of the present disclosure. Thus, the scope of protection of the present disclosure should be defined by the scope of protection of the claims.

1. A method for invoking a service, performed by a session management function (SMF) network element, the method comprising:
receiving a service invocation request, wherein the service invocation request indicates at least one of a terminal requesting to invoke a service or a service that the terminal requests to invoke;
establishing a connection with a first network element, wherein the first network element is a network element providing the service that the terminal requests to invoke;
determining a resource configured to execute the service by interacting with a base station; and
transmitting resource indication information to the first network element, wherein the resource indication information indicates the resource configured to execute the service, and the resource indication information is configured for the first network element to establish a user plane connection with the terminal based on the resource indication information.

2. The method according to claim 1, wherein the service invocation request comprises at least one of the following:
an identifier of the terminal requesting to invoke the service;
a public land mobile network identity (PLMN ID) of the terminal requesting to invoke the service;
a service identifier (service ID) of the service that the terminal requests to invoke; or
a service type of the service that the terminal requests to invoke.

3. The method according to claim 1, wherein the service that the terminal requests to invoke comprises at least one of the following:
a sensing service;
a computing power service; or
an artificial intelligence (AI) service.

4. The method according to claim 1, wherein receiving the service invocation request comprises:
receiving the service invocation request transmitted by an access and mobility management function (AMF) network element, wherein the service invocation request at the AMF network element is determined by the AMF network element based on transmission by the terminal.

5. The method according to claim 1, wherein establishing the connection with the first network element comprises:
requesting to query subscription information of the terminal from a unified data management (UDM) network element; and
determining the first network element and establishing a session connection with the first network element, in a case where a query result transmitted by the UDM network element indicates that the subscription information of the terminal is queried.

6. The method according to claim 5, wherein determining the first network element comprises:
determining a corresponding first network element based on the service that the terminal requests to invoke.

7. The method according to claim 5, wherein the method further comprises:
transmitting a service invocation failure message in a case where the query result transmitted by the UDM network element indicates that no subscription information of the terminal is queried.

8. The method according to claim 1, wherein determining the resource configured to execute the service by interacting with the base station comprises:
transmitting a resource scheduling request to the base station, wherein the resource scheduling request is configured to request the base station to schedule for the terminal the resource configured to execute the service; and
receiving resource indication information transmitted by the base station, wherein the resource indication information indicates the resource scheduled by the base station for the terminal and configured to execute the service.

9. The method according to claim 8, wherein the resource scheduling request comprises an identifier of the first network element, and the resource scheduling request is configured to request the base station to schedule, based on the identifier of the first network element, for the terminal the resource configured to execute the service.

10. A method for invoking a service, performed by a base station, the method comprising:
receiving a resource scheduling request transmitted by a session management function (SMF) network element, wherein the resource scheduling request is configured to request the base station to schedule for a terminal a resource configured to execute a service;
scheduling the resource configured to execute the service for the terminal; and
transmitting resource indication information to the SMF network element, wherein the resource indication information indicates the resource scheduled by the base station for the terminal and configured to execute the service.

11. The method according to claim 10, wherein the resource scheduling request comprises an identifier of a first network element; and
scheduling the resource configured to execute the service for the terminal comprises:
scheduling the resource configured to execute the service for the terminal based on the identifier of the first network element.

12-13. (canceled)

14. A method for invoking a service, performed by a terminal, the method comprising:
transmitting a service invocation request to an access and mobility management function (AMF) network element, wherein the service invocation request indicates at least one of a terminal requesting to invoke a service or a service that the terminal requests to invoke;
receiving a resource scheduled by a base station and configured to execute the service;
establishing a user plane connection with a first network element based on the resource configured to execute the service, wherein the first network element is a network element providing the service that the terminal requests to invoke; and
invoking the service by communicating with the first network element.

15-19. (canceled)

20. A communication device, comprising one or more processors and a memory; wherein the memory stores a computer program; and the one or more processors, when collectively executing the computer program stored in the memory, causes the communication device to perform the method according to claim 1.

21. (canceled)

22. A non-transitory computer-readable storage medium, configured to store instructions, wherein the instructions, when executed by one or more processors, cause the one or more processors to perform the method according to claim 1.

23-25. (canceled)

26. A communication system, comprising:
a session management function (SMF) network element configured to perform the method according to claim 1;
the first network element, wherein the first network element is configured to:
establish a connection with the SMF network element;
receive resource indication information transmitted by the SMF network element, wherein the resource indication information indicates a resource configured to execute the service that the terminal requests to invoke;
establish a user plane connection with the terminal based on the resource indication information; and
communicate with the terminal for invocation of the service; and
an access and mobility management function (AMF) network element configured to:
receive a service invocation request transmitted by the terminal, wherein the service invocation request indicates at least one of the terminal requesting to invoke a service or the service that the terminal requests to invoke; and
transmit the service invocation request to the SMF network element.

27. A communication device, comprising one or more processors and a memory; wherein the memory stores a computer program; and the one or more processors, when collectively executing the computer program stored in the memory, causes the communication device to perform the method according to claim 10.

28. A communication device, comprising one or more processors and a memory;
wherein the memory stores a computer program; and the one or more processors, when collectively executing the computer program stored in the memory, causes the communication device to perform the method according to claim 14.

29. A non-transitory computer-readable storage medium, configured to store instructions, wherein the instructions, when executed by one or more processors, cause the one or more processors to perform the method according to claim 10.

30. A non-transitory computer-readable storage medium, configured to store instructions, wherein the instructions, when executed by one or more processors, cause the one or more processors to perform the method according to claim 14.

31. The method according to claim 5, wherein the subscription information is configured to indicate whether the terminal has permission to invoke the service.
